(19) United States
(12) Patent Application Publication
(10) Pub. No.: US 2006/0290713 A1
(43) Pub. Date: Dec. 28, 2006

(54) SYSTEM, METHOD AND COMPUTER-READABLE MEDIUM FOR PRODUCING INDICATING FIGURES

(75) Inventor: Ming Che Lo, Taipei City (TW)

Correspondence Address: NIKOLAI & MERSEREAU, P.A., 900 SECOND AVENUE SOUTH, SUITE 820, MINNEAPOLIS, MN, 55402, US

(73) Assignee: STRATEGY COMPANION TAIWAN CORP., Taipei City (TW)

(21) Appl. No.: 11/162,316

(22) Filed: Sep. 6, 2005

(30) Foreign Application Priority Data
Jun. 28, 2005 (TW) 094121689

(51) Int. Cl. G09G 5/00

(52) U.S. Cl. 345/619

(57) ABSTRACT

This present invention provides a system, method and computer-readable medium thereof that allow a user to produce an indicating figure from a multidimensional data table by means of drag-and-drop functions. The invention displays the multidimensional data table, which has a set of measurement data and category data; displays a predetermined dropping area; and permits a user to: select a column from the multidimensional data table; drag the column to the predetermined dropping area; and drop the column to produce the indicating figure showing the measure data and category data included in the column.

### BACKGROUND OF THE INVENTION

1. Field of the Invention

The present invention relates to a system, method and computer-readable medium for producing indicating figures, and more particularly, to a system, method and computer-readable medium thereof for using drag-and-drop technology to produce indicating figures from a multidimensional data table.

2. Description of the Related Art

Indicating figures (such as digital dashboard figures, indicator drawings, traffic signal figures or the like) are often used for displaying digital data so that users can quickly comprehend the digital data. For users, indicating figures provide a very convenient interface.

Although indicating figures have been used for the displaying of data, there continue to be problems in the transferring of the data into an indicating figure. This is especially true in web-based OLAP (online analytical processing) environments, where the transferring technologies are more complicated.

Generally, in the prior art technology, a user needs to add a new indicating figure, such as a dashboard, and then set up a data source to be displayed by the dashboard. At the same time, in the prior art technology, the user is usually required to write new program code to set up the data source that is to be displayed by the dashboard.

Therefore, it is desirable to provide a system, method and computer-readable medium for producing indicating figures that mitigates and/or obviates the aforementioned problems.

### SUMMARY OF THE INVENTION

The present invention relates to a system, method and computer-readable medium for producing indicating figures, and more particularly, to a system, method and computer-readable medium thereof for using drag-and-drop technology to produce an indicating figure or figures from a multidimensional data table.

The system of the present invention comprises:

a memory for storing a plurality of commands;

a display for displaying the webpage, the multidimensional data table and the indicating figure;

an input device permitting a user to select data from the multidimensional data table to be displayed as the indicating figure on the display;

processor electrically connected to the memory, the display and the input device, for executing the plurality of commands stored in the memory.

The present invention is capable of displaying a multidimensional data table having a set of measurement data and category data; and a predetermined dropping area for placing the indicating figure.

The present invention permits a user to: (a) select a column from the multidimensional data table; (b) drag the column to the predetermined dropping area; and (c) drop the column to produce the indicating figure showing the measurement data and category data included in the column.

In one embodiment of the present invention, the multidimensional data table is a pivot table; and the present invention is applied in an OLAP (online analytical processing) environment.

In one embodiment of the present invention, the user can utilize a drag-and-drop function to change a position of the indicating figure in the predetermined dropping area. Similarly, the user can combine the plurality of indicating figures to change a position of the plurality of indicating figures in the predetermined dropping area by utilizing a single drag-and-drop operation.

In one embodiment of the present invention, the user can set up or change a mode of the indicating figure as a dashboard, a thermometer, a traffic signal, a bar chart or an indicator. Moreover, the user can set up a background picture as a world map for the predetermined dropping area and perform drag-and-drop operations to drag indicating figures to their related positions on the world map.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a system of the present invention.

FIG. 2 is a schematic drawing of displaying a multidimensional data table on a webpage according to the system of the present invention.

FIG. 3 is a schematic drawing of displaying a predetermined dropping area on the webpage, which is used for placement of an indicating figure according to the system of the present invention.

FIG. 4 is a schematic drawing showing a user producing an indicating figure by utilizing a drag-and-drop function with an indicating figure according to the system of the present invention.

FIG. 5 is a schematic drawing showing a user changing the position of the indicating figure shown in FIG. 4 according to the system of the present invention.

FIG. 6 is a schematic drawing showing a plurality of indicating figures generated according to the system of the present invention.

FIG. 7 is a schematic drawing showing a user changing the position of the indicating figures shown in FIG. 6 according to the system of the present invention.

FIG. 8 is a schematic drawing showing the user setting a world map as a background picture for the predetermined dropping area according to the system of the present invention.

FIG. 9 is a schematic drawing of changing a mode of the indicating figure according to the system of the present invention.

FIG. 10 is a flow chart of a method of the present invention.

### DETAILED DESCRIPTION OF THE PREFERRED EMBODIMENT

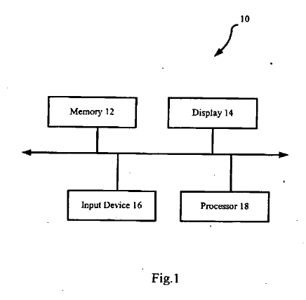

Please refer to FIG. 1 to FIG. 9, which disclose a user generating an indicating figure on a webpage from a multidimensional data table using drag-and-drop functionality.

FIG. 1 is a schematic drawing of a system of the present invention. As shown in FIG. 1, in an embodiment of the present invention, the system 10 of the present invention comprises a memory 12, a display 14, an input device 16 and a processor 18. The memory 12, the display 14, the input device 16 and the processor 18 can all be part of a single computer system, or may be individual components in different computer systems that are connected via a network. The system 10 is utilized in an OLAP (online analytical processing) environment.

In the system 10 of the present invention, the user can utilize the input device 16 to control the processor 18 to execute commands stored in the memory 12 to choose and display data from the multidimensional data table, which is then shown in the indicating figure on the display 14.

The following disclosure further explains how to utilize the system 10 of the present invention to allow the user to produce an indicating figure or figures from a multidimensional data table by using drag-and-drop functions and the display 14.

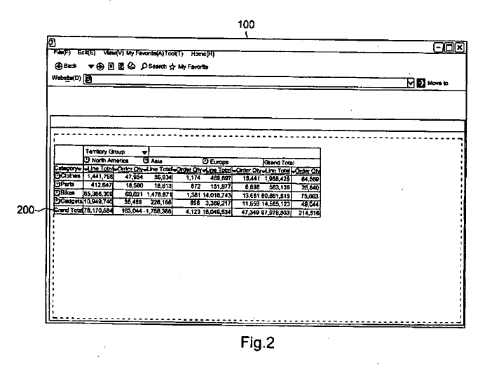

FIG. 2 is a schematic drawing of displaying a multidimensional data table on a webpage according to the system of the present invention. As shown in FIG. 2, in the system 10 of the present invention, a webpage 100 is shown on the display 14, and a multidimensional data table 200 is displayed on the webpage. In an embodiment of the present invention, the multidimensional data table 200 is a pivot table 200, but this should not be construed as a limitation of the invention. As shown in FIG. 2, the pivot table 200 comprises a set of measurement and category data. For example, in the pivot table 200, “North America” and “Clothes” are category data; a corresponding value of the “North America” and “Clothes” data is “1,441,798”, which is the measurement data. The technology for displaying the webpage and displaying the multidimensional data table or the pivot table are all very well-known in the prior art, and so requires no further detailed description.

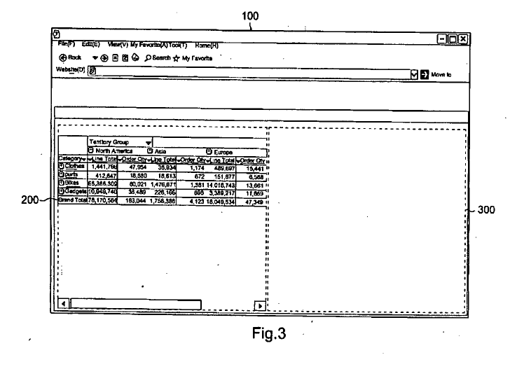

FIG. 3 is a schematic drawing of displaying a predetermined dropping area on the webpage, which is used for placing the indicating figure according to the system of the present invention. As shown in FIG. 3, in the system 10 of the present invention, a predetermined dropping area 300 is displayed in the webpage 100 on the display 14 in order to permit the user to place the indicating figure or figures.

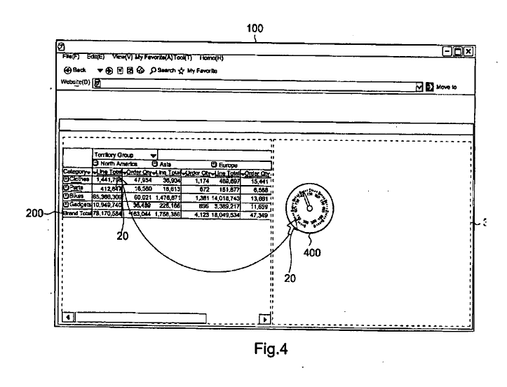

Please refer to FIG. 4. FIG. 4 is a schematic drawing showing a user producing an indicating figure using drag-and-drop technology according to the system of the present invention. As shown in FIG. 4, in the system 10 of the present invention, the user can utilize the input device 16, such as a computer mouse, a keyboard, a touch pad, a trackball, an optical pen, etc., to control the processor 18 to execute commands stored in the memory 12 to use drag-and-drop functions to produce the indicating figure.

As shown in FIG. 4, the user may move a cursor 20 of the input device 16 to a column of the pivot table 200 (for example, the column that indicates that the category data are “North America” and “Clothes”, and that the measurement value is “1,441,798”) and click on this column to drag-and-drop this column to any position in the predetermined dropping area 300. The user can thereby transform the measurement data and the category data in that column to an indicating figure 400 shown in the predetermined dropping area 300.

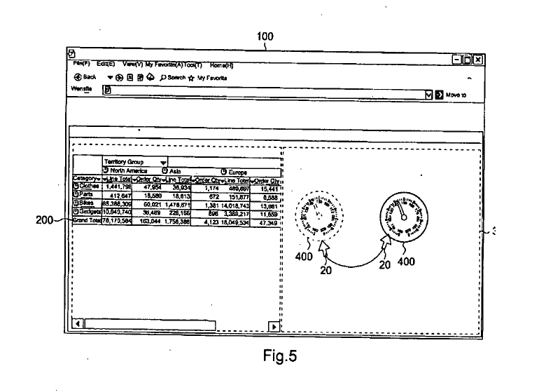

In one embodiment of the present invention, after producing indicating figure 400, the user can also change the position of the indicating figure 400 in the predetermined dropping area 300. For example, as shown in FIG. 5, when the user moves the cursor 20 of the input device 16 onto the indicating figure 400 displayed in the predetermined dropping area 300, he or she can click the indicating figure 400 and drag-and-drop it to another position in the predetermined dropping area 300.

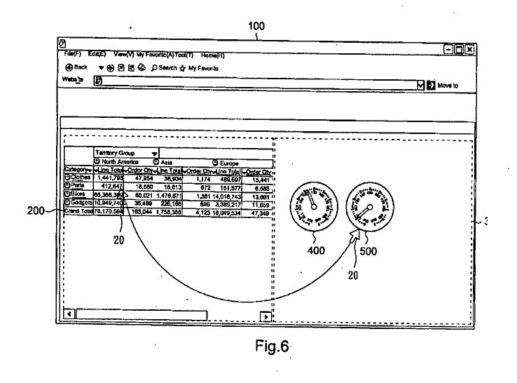

In one embodiment of the present invention, the system 10 of the present invention enables the user to repeat the above-mentioned operations via the input device 16 to select other columns in the pivot table 200 and thereby produce a plurality of indicating figures in the predetermined dropping area 300. For example, as shown in FIG. 6, the user can move the cursor 20 of the input device 16 onto another column of the pivot table 200 (for example, the column with category data “North America” and “Parts” and with measurement data “412,647”) and drag-and-drop on this column to produce another indicating figure 500 in the predetermined dropping area 300.

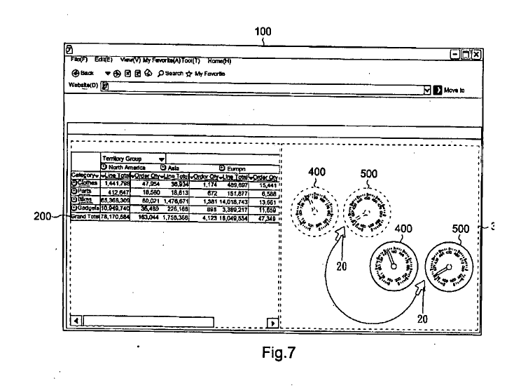

In one embodiment of the present invention, when there are pluralities of indicating figures, the system 10 of the present invention also permits the user to connect the plurality of indicating figures with each other and change the positions of the indicating figures in the predetermined dropping area 300 by using drag-and-drop functions. For example, as shown in FIG. 7, the user can move the cursor 20 of the input device 16 onto the connected indicating figures 400 and 500 and then use drag-and-drop functions to change the position of the connected indicating figures 400 and 500 in the predetermined dropping area 300.

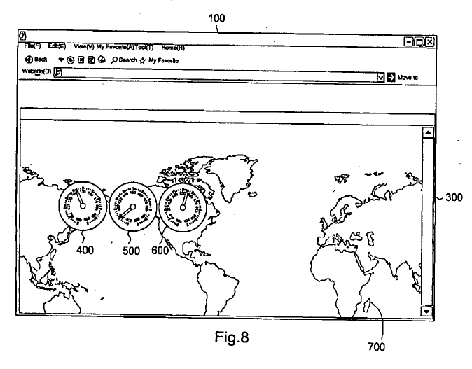

In one embodiment of the present invention, the user can also setup or change the background picture of the predetermined dropping area 300; for example, the user may set or change the background picture to an image of a world map, a company hierarchy drawing, a factory layout, etc. As shown in FIG. 8, the user can set the background picture of the predetermined dropping area 300 to a world map 700 to display related data. For example, FIG. 8 shows an indicating figure 600 of a column with category data as “North America” and “Bikes”, and the measurement data as “65,366,309”.

In the system 10 of the present invention, the user can move any indicating figure, so when the background of the predetermined dropping area 300 is the world map 700, the user can further zoom in or out of the world map 700 and drag-and-drop each indicating figure to a related position corresponding to the data on the world map 70. For example, the indicating figures 400, 500 and 600 all display data related to “North America”, so the user can drag-and-drop the indicating figures 400, 500 and 600 to North America on the world map 700.

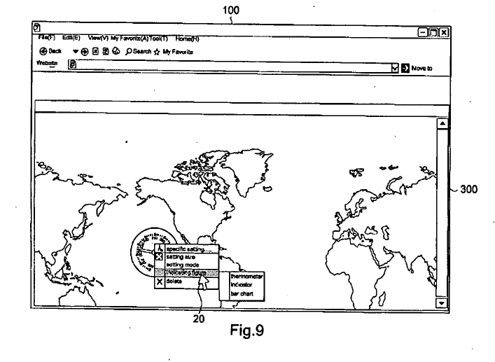

In one embodiment of the present invention, the user can set or change a mode of the indicating figure to a dashboard mode, a thermometer mode, a traffic signals mode, a bar chart mode or an indicator mode. As shown in FIG. 9, the user can use the input device 16 to control the processor 18 to execute the commands stored in the memory 12 to change the indicating figure from a dashboard mode to a thermometer mode, an indicator mode or a bar chart mode.

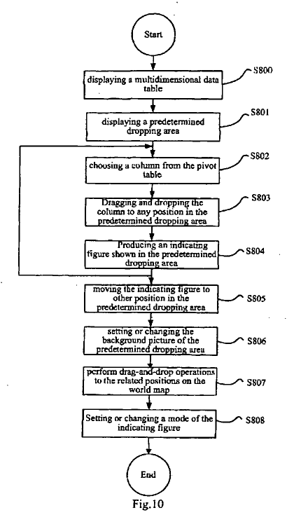

The present invention also provides a method for enabling a user to produce an indicating figure or figures on a webpage from a multidimensional data table by using drag-and-drop functionalities. Please refer to FIG. 10. FIG. 10 is a flow chart of a method of the present invention.

As shown in FIG. 10, the method of the present invention comprises steps S800, S801, S802, S803, S804, S805, S806, S807 and S808.

First, step S800 is performed to display a multidimensional data table; the multidimensional data table comprises a set of measurement and category data. For example, as shown in FIG. 2, a webpage 100 is shown on the display 14, and a multidimensional pivot table 200 is displayed on the webpage 100.

Moreover, step S801 is performed to display a predetermined dropping area. For example, as shown in FIG. 3, in the system 10 of the present invention, a predetermined dropping area 300 is displayed in the webpage 100 on the display 14. In one embodiment of the present invention, the predetermined dropping area 300 and the pivot table 200 can be showed together, or the predetermined dropping area 300 can be displayed by opening a new window.

When the pivot table 200 and the predetermined dropping area 300 are both displayed, step S802 is performed to enable the user to choose a column from the pivot table 200. For example, as shown in FIG. 4, the user may choose the column that indicates the category data of “North America” and “clothes”, and the measurement value of “1,441,798”.

Step S803 is then performed; as shown in FIG. 4, the user can drag-and-drop this column to any position in the predetermined dropping area 300; and in step S804, the user can transform the measurement data and the category data in that column to an indicating figure 400 shown in the predetermined dropping area 300.

In one embodiment of the present invention, the user can repeat steps S802 to S804; as shown in FIG. 6, to produce a plurality of indicating figures 400 and 500 in the predetermined dropping area 300.

After producing the indicating figure, the present invention can selectively perform step S805; as shown in FIG. 5, to move the indicating figure 400 to other position in the predetermined dropping area 300; or, as shown in FIG. 7, to move a plurality of indicating figures 400 and 500 to other positions in the predetermined dropping area 300 by using a single drag-and-drop operation.

Next, step S806 is performed to set or change the background picture of the predetermined dropping area 300. As shown in FIG. 8, the user can set the background picture of the predetermined dropping area 300 to display a world map 700.

Step S807 is performed to perform drag-and-drop operations to the related positions on the world map 700 for each indicating figure. For example, the user can drag-and-drop the indicating figures 400, 500 and 600 to the North America position on the world map 700. The present invention can selectively perform step S808 to set or change a mode of the indicating figure, such as changing to a dashboard mode; a thermometer mode, a traffic signal mode, a bar chart mode or an indicator mode. As shown in FIG. 9, the user can change the indicating figure from the dashboard mode to the thermometer mode, the mark mode or the bar chart mode.

Additionally, the present invention also provides a computer-readable medium having a plurality of computer-executable commands to execute the above-mentioned method.

Although the present invention has been explained in relation to its preferred embodiment, it is to be understood that many other possible modifications and variations can be made without departing from the spirit and scope of the invention as hereinafter claimed.

What is claimed is:

1. A method for using drag-and-drop to produce an indicating figure on a webpage from a multidimensional data table, the method comprising:
(1) displaying the multidimensional data table having a set of measurement data and category data;
(2) displaying a predetermined dropping area; and
(3) permitting a user to:
(a) select a column from the multidimensional data table;
(b) drag the column to the predetermined dropping area; and
(c) drop the column to produce the indicating figure showing the measurement data and category data included in the column.

2. The method as claimed in claim 1, wherein the method is applied in an OLAP (online analytical processing) environment.

3. The method as claimed in claim 1, wherein the indicating figure is a dashboard, a thermometer, a traffic signal, a bar chart or an indicator.

4. The method as claimed in claim 1, wherein the multidimensional data table is a pivot table.

5. The method as claimed in claim 1 further comprising:
permitting the user to utilize a drag-and-drop function to change a position of the indicating figure in the predetermined dropping area.

6. The method as claimed in claim 1 further comprising:
permitting the user to repeat steps (a) to (c) to generate a plurality of indicating figures in the predetermined dropping area.

7. The method as claimed in claim 6 further comprising:
permitting the user to combine the plurality of indicating figures to change a position of the plurality of indicating figures in the predetermined dropping area by utilizing a single drag-and-drop operation.

8. The method as claimed in claim 1 further comprising:
permitting the user to set up a mode of the indicating figure.

9. The method as claimed in claim 1 further comprising:
permitting the user to set up a background picture for the predetermined dropping area.

10. The method as claimed in claim 9 further comprising:
permitting the user to set up the background picture as a world map.

11. The method as claimed in claim 1, wherein the category data of the indicating figure further includes location data, and the method further comprises:
permitting the user to drag-and-drop the indicating figure to a position on the world map corresponding to the location data.

12. A system permitting a user to produce an indicating figure on a webpage from a multidimensional data table by utilizing drag-and-drop functionalities, the system comprising:
a memory for storing a plurality of commands;
a display for displaying the webpage, the multidimensional data table and the indicating figure;
an input device permitting a user to select data from the multidimensional data table to be displayed as the indicating figure on the display;
a processor electrically connected to the memory, the display and the input device, for executing the plurality of commands stored in the memory to provide the following means:
(1) displaying the multidimensional data table, the multidimensional data table having a set of measurement and category data;
(2) displaying a predetermined dropping area; and
(3) enabling a user to:
(a) select a column from the multidimensional data table;
(b) drag the column to the predetermined dropping area; and
(c) drop the column to produce the indicating figure showing the measurement and category data included in the column.

13. The system as claimed in claim 12, wherein the indicating figure is a dashboard, a thermometer, a traffic signal or an indicator.

14. The system as claimed in claim 12, wherein the means provided by the processor further comprises:
enabling a user to change a position of the indicating figure in the predetermined dropping area by utilizing a drag-and-drop function.

15. The system as claimed in claim 12, wherein the means provided by the processor further comprises:
enabling a user to repeat steps (a) to (c) to generate a plurality of indicating figures in the predetermined dropping area.

16. The system as claimed in claim 15, wherein the means provided by the processor further comprises:
permitting the user to combine the plurality of indicating figures to change a position of the plurality of indicating figures in the predetermined dropping area by utilizing a single drag-and-drop operation.

17. The system as claimed in claim 12, wherein the means provided by the processor further comprises:
enabling a user to set up mode of the indicating figure.

18. The system as claimed in claim 12, wherein the means provided by the processor further comprises:
enabling a user to set up a background picture for the predetermined dropping area.

19. The system as claimed in claim 18, wherein the category data of the indicating figure further includes location data, and the means provided by the processor further comprises:
enabling a user to drag-and-drop the indicating figure to a position on the world map corresponding to the location data.

20. A computer-readable medium having a plurality of computer-executable commands to execute the method claimed in claim 1.
